(19) United States
(12) Patent Application Publication
(10) Pub. No.: US 2012/0117242 A1
(43) Pub. Date: May 10, 2012

(54) SERVICE LINKAGE SYSTEM AND INFORMATION PROCESSING SYSTEM

(75) Inventors: Hidetaka AOKI, Tokyo (JP); Hiroki MIYAMOTO, Fujisawa (JP)

(73) Assignee: Hitachi, Ltd.

(21) Appl. No.: 13/287,145

(22) Filed: Nov. 2, 2011

(30) Foreign Application Priority Data
Nov. 5, 2010 (JP) 2010-248478

(51) Int. Cl. G06F 15/173

(52) U.S. Cl. 709/226

(57) ABSTRACT

An object of the present invention is to enhance the followability of the automatic scaling of a whole system corresponding to an increase of requests in a service linkage system for linking plural services. A cloud that executes intermediate service receives an estimate of the output of service at a previous stage by an output rate estimating unit and an information gathering response from a cloud management server, estimates an output rate, and outputs the estimate to service at a following stage. A scaling control unit receives the estimate of the output of the service at the previous stage and the information gathering response, determines resources allocated to the intermediate service, and outputs a scaling request to the cloud management server and the output rate estimating unit.

### CLAIM OF PRIORITY

The present application claims priority from Japanese patent application JP2010-248478 filed on Nov. 5, 2010, the content of which is hereby incorporated by reference into this application.

### BACKGROUND OF THE INVENTION

The present invention relates to a system that provides various services via a network, particularly relates to a service linkage system where plural information processing systems provide service with them linked and the information processing system.

For one embodiment of an information processing system, a cloud is prevailing. In the NIST Definition of Cloud Computing, NIST Special Publication 800-145, http://csrc.nist.gov/publications/nistpubs/800-145/SP800-145.pdf, cloud computing is defined as “a model for enabling ubiquitous, convenient, on-demand network access to a shared pool of configurable computing resources (e.g., networks, servers, storage, applications, and services) that can be rapidly provisioned and released with minimal management effort or service provider interaction”, and an information processing system that realizes the cloud computing is equivalent to the cloud. Besides, the utilization of linked clouds that realize single service with plural linked clouds is spreading, using the plural clouds according to applications, quality, costs and others, and the still more prevalence in the future is expected for solution for enhancing a return on investment (ROI) in information and communication technology (ICT) by enterprises.

For such a cloud, for example, in Amazon EC2 (Elastic Compute Cloud) disclosed in http://awsdocs.s3.amazonaws.com/EC2/2010-06-15/ec2-dg-2010-06-15.pdf and others, automatic scaling according to a situation of a load can be realized by functions provided by Amazon EC2. Central processing units (CPUs) load values and performance such as input/output (I/O) to/from a disk and I/O to/from a network are monitored for each instance on EC2 by “Amazon CloudWatch” and a policy of scaling can be set based upon gathered values by “Auto Scaling”. At that time, traffic can be distributed utilizing a load balancer and “Elastic Load Balancing”. Further, correspondence to “Auto Scaling” linked in plural independent locations (Availability Zone) is also enabled.

For a patent related to such automatic scaling, for example, JP-A No. 2007-128382 and JP-A No. 1999-282695 can be given.

### BRIEF SUMMARY OF THE INVENTION

However, automatic scaling in the example of Amazon EC2 is automatic scaling by a single cloud, and to link plural clouds and to realize single service, that is, linkage service, assuming that the above-mentioned automatic scaling is applied to each cloud, scaling sequentially continues in a way that resources allocated to a first-layer cloud are increased as requests to the first-layer cloud increase when requests from a client to the linkage service increase, the increase of requests to a second-layer cloud is caused and further, resources allocated to the second-layer cloud are increased.

Therefore, since the automatic scaling of each cloud requires time because of delay due to a monitoring interval and delay due to the activation of a new virtual machine (VM) and in addition, scaling is propagated to each cloud in order, it is considered that a problem exists that the followability of the whole system in accordance with the increase of requests is low.

Such a problem may also be caused when plural general information processing systems including a cloud are linked to realize linkage service. That is, assuming that automatic scaling technique in the above-mentioned two patent documents is applied to each information processing system for realizing linkage service, scaling sequentially continues in a way that resources allocated to a first-layer information processing system are increased as requests to the first-layer information processing system increase when requests from a client to the linkage service increase, the increase of requests to a second-layer information processing system is caused and further, resources allocated to the second-layer information processing system are increased. In this case, since the automatic scaling of each information processing system also requires time because of delay due to a monitoring interval and delay due to a resource allocation process and in addition, scaling is propagated to each information processing system in order, the followability of the whole system in accordance with the increase of requests is deteriorated.

The above-mentioned two patent documents relate to automatic scaling technique in a single cluster and the problem when plural clouds described above and plural information processing systems are linked to realize single service, namely, linkage service is not reviewed.

An object of the present invention is to solve the above-mentioned problem and to provide a service linkage system where the followability of automatic scaling is enhanced by advancing automatic scaling starting timing at the following stage according to the increase of requests and its information processing system.

To achieve the object, the present invention provides a service linkage system in which plural services executed in one or more information processing systems are linked and resources allocated to second service at the following stage of first service are determined using a result acquired by estimating the processing performance of the first service of the plural services.

Besides, to achieve the object, the present invention provides a service linkage system where the information processing system in the above-mentioned service linkage system is provided with a performance estimating unit to which a result acquired by estimating the processing performance of first service is input and which estimates the processing performance of the second service based upon the result of the estimate and a resource allocation control unit that determines resources allocated to the second service.

Further, to achieve the object, the present invention provides an information processing system which is based upon an information processing system that provides plural services in linkage with another information processing system connected via a network, which includes a management unit and plural servers connected to the management unit and managed by the management unit and in which the server is provided with a storage that stores a virtual server program and a processor that executes the virtual server program and realizes a virtual server and the processor determines and allocates resources allocated to second service at the following stage of first service using a result acquired by estimating the processing performance of the first service of the plural services.

Since estimated performance can be propagated to the information processing system at the following stage in the service linkage system that uses the plural information processing systems, resources can be promptly allocated to each information processing system according to the variation of requests for service.

### BRIEF DESCRIPTION OF THE DRAWINGS

FIG. 1 shows the whole configuration of a service linkage system in a first embodiment;

FIG. 2 shows one example of the configuration of a server in the first embodiment;

FIG. 3 shows one example of the configuration of a cloud management server in the first embodiment;

FIG. 4A shows one example of an output rate estimating unit and a scaling control unit in the first embodiment;

FIG. 4B shows another example of the output rate estimating unit and the scaling control unit in the first embodiment;

FIG. 4C shows further another example of the scaling control unit in the first embodiment;

FIG. 5 shows variations of the output rate estimating unit in the first embodiment;

FIG. 6 shows variations of the scaling control unit in the first embodiment;

FIG. 7 shows the combinations of the output rate estimating unit and the scaling control unit for a cloud in the first embodiment;

FIG. 8A shows one example of a variation of the output rate estimating unit in the first embodiment;

FIG. 8B shows another example of a variation of the output rate estimating unit in the first embodiment;

FIG. 8C shows another example of a variation of the output rate estimating unit in the first embodiment;

FIG. 8D shows another example of a variation of the output rate estimating unit in the first embodiment;

FIG. 8E shows another example of a variation of the output rate estimating unit in the first embodiment;

FIG. 8F shows another example of a variation of the output rate estimating unit in the first embodiment;

FIG. 8G shows another example of a variation of the output rate estimating unit in the first embodiment;

FIG. 9 shows a work flow of the service linkage system in the first embodiment;

FIG. 10 shows relation between the output rate estimating unit and the scaling control unit per service in the work flow shown in FIG. 9 in the first embodiment;

FIG. 11 shows a type of application program interfaces (API) provided to a cloud user by the cloud management server in the first embodiment;

FIG. 12A shows one example of a process flow of a scaling control unit A in the first embodiment;

FIG. 12B shows one example of a process flow of a scaling control unit B in the first embodiment;

FIG. 13A shows one example of the processing of an output rate estimating unit A in the first embodiment;

FIG. 13B shows one example of the processing of an output rate estimating unit E in the first embodiment;

FIG. 13C shows one example of the processing of an output rate estimating unit D in the first embodiment; and

FIG. 14 shows one example of a function f (x) used in the output rate estimating unit D in the first embodiment.

### DETAILED DESCRIPTION OF THE INVENTION

Referring to the drawings, an embodiment of the present invention will be described below. In this specification, a system which provides various services via a network and is represented by a cloud is called an information processing system, and a system where plural information processing systems provide various services with them linked is called a service linkage system.

### First Embodiment

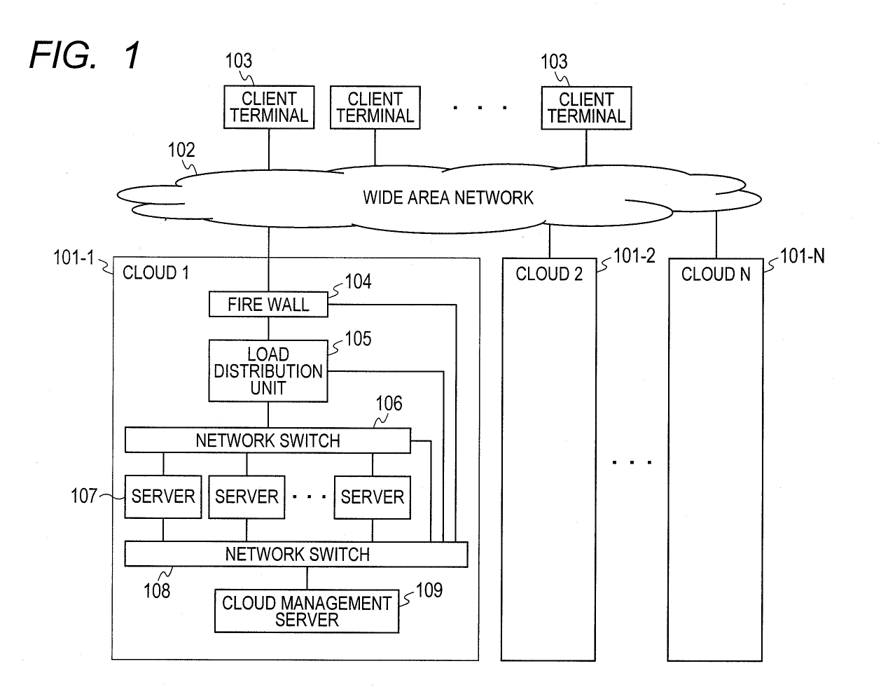

FIG. 1 shows the whole configuration of a service linkage system in a first embodiment.

As shown in FIG. 1, reference numerals 101-1, 101-2, - - - , 101-N denote clouds 1, 2, - - - , N. A reference numeral 102 denotes a network showing a wide area network as an example and 103 denotes plural client terminals. Each cloud 101 includes a firewall 104 connected to the network 102, a load distribution unit 105 connected to the firewall 104, a network switch 106 connected to the load distribution unit 105, plural servers 107, a network switch 108 connected to the plural servers 107 and a cloud management server 109 which is connected to the network switch 108 and functions as a cloud manager.

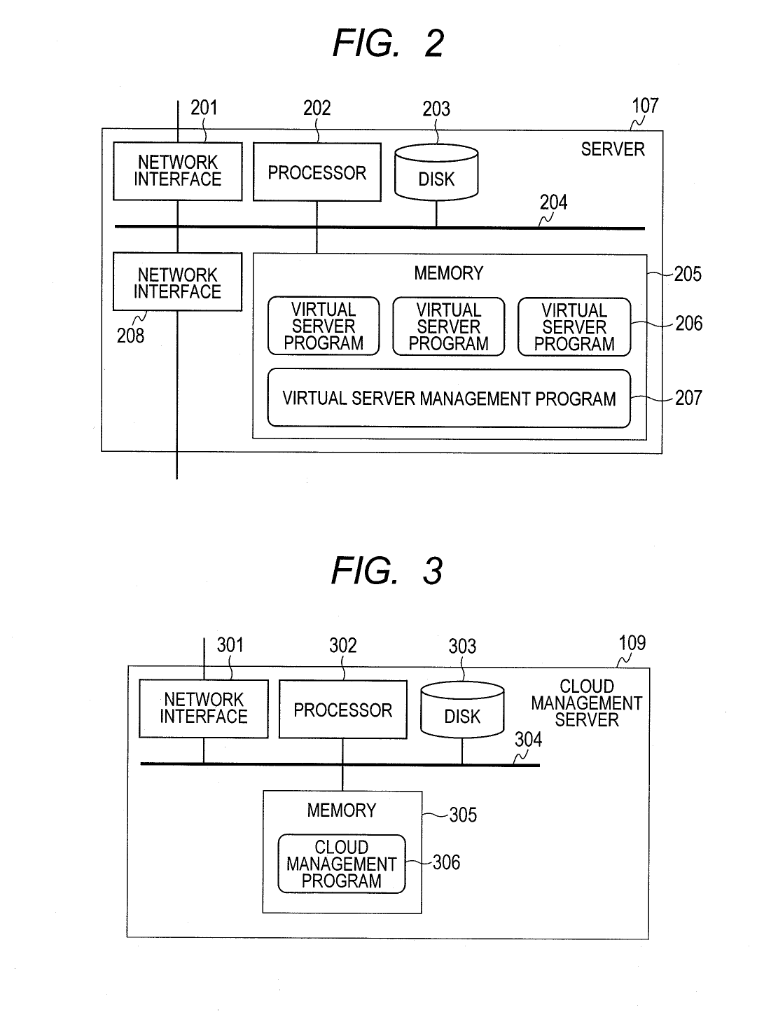

FIG. 2 shows one example of the configuration of the server 107 in this embodiment and FIG. 3 shows one example of the configuration of the cloud management server 109 in this embodiment. As shown in FIG. 2, the server 107 has a normal computer configuration and includes network interfaces 201, 208 connected to respective network switches 106, 108, an internal bus 204 connected to these network interfaces, a processor 202 such as CPU which is connected to the internal bus 204 and configures a processing unit, a disk 203 that functions as a storage and a memory 205. In the memory 205, virtual server programs 206 and a virtual server management program 207 respectively executed in the processor 202 are stored. Each of the plural servers 107 can configure plural virtual servers that realize desired function and service by executing the plural virtual server programs 206 for realizing the desired function and service.

Similarly, the cloud management server 109 shown in FIG. 3, which is the cloud manager, includes a processor 302 connected to an internal bus 304 connected to a network interface 301 connected to the network switch 108, a disk 303 and a memory 305, and in the memory 305, a cloud management program 306 executed in the processor 302 is stored. The cloud management server 109 functions as the manger that manages the plural servers 107 in the cloud 101 which is an information processing system by executing the cloud management program 306 in the processor 302.

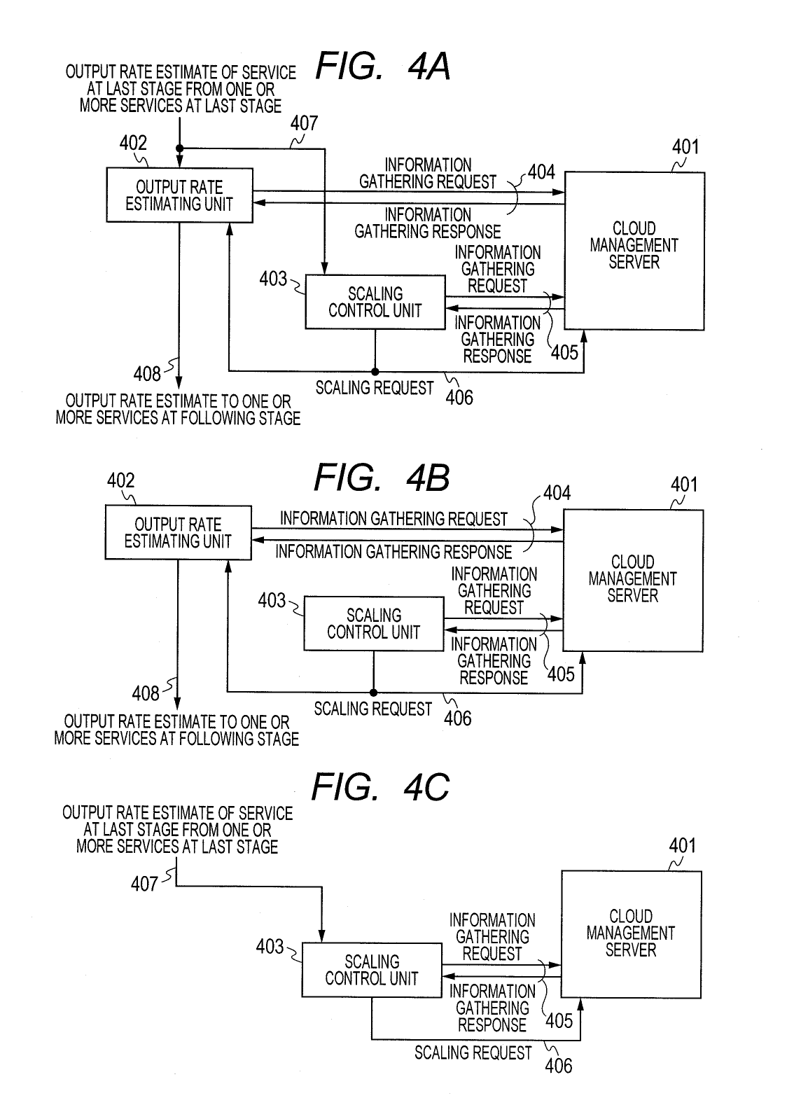

FIGS. 4A, 4B and 4C show concrete examples of full sets each of which is configured by an output rate estimating unit that functions as a performance estimating unit formed in the cloud of the service linkage system in the first embodiment and a scaling control unit that functions as a resource allocation control unit. FIGS. 4A, 4B and 4C correspond to intermediate service, starting point service and end point service in a work flow of the service linkage system where plural information processing systems provide various services with them linked.

The output rate estimating unit 402 and the scaling control unit 403 in FIGS. 4A, 4B and 4C can be realized by processing a program in plural servers in each cloud which is the information processing system shown in FIG. 1 and plural virtual servers formed in the servers.

FIG. 4A shows an example corresponding to the intermediate service in the work flow and includes the output rate estimating unit 402 which is the performance estimating unit and the scaling control unit 403 which is the resource allocation control unit. A cloud management server 401 corresponding to the cloud management server 109 in the cloud 101 shown in FIG. 1 exchanges an information gathering request and an information gathering response 404, 405 with the output rate estimating unit 402 and the scaling control unit 403. In the case of the intermediate service shown in FIG. 4A, an output rate estimate 407 from one or more services at the previous stage are input to the output rate estimating unit 402 and the scaling control unit 403. The output rate estimating unit 402 estimates an output rate of the corresponding service based upon the output rate estimate 407, the information gathering response 404 and others and transmits a result of the estimate to one or more services at the following stage as an output rate estimate 408. In the service linkage system where plural services including the service at the previous stage, the intermediate service and the service at the following stage are linked, when the service at the previous stage is called first service, the service at a middle stage can be called second service and the service at the following stage can be called third service.

The scaling control unit 403 similarly receives the output rage estimate 407 from one or more services at the previous stage and the information gathering response 405, and outputs and transmits a scaling request 406 to the cloud management server 401 and the output rate estimating unit 402.

FIG. 4B shows an example corresponding to the starting point service and includes the output rate estimating unit 402 and the scaling control unit 403 as in FIG. 4A. The cloud management server 401 exchanges an information gathering request and an information gathering response 404, 405 with the output rate estimating unit 402 and the scaling control unit 403. In the case of the starting point service shown in FIG. 4B, the output rate estimating unit 402 estimates an output rate based upon the information gathering response 404 from the cloud management server 401 and a scaling request 406 from the scaling control unit 403, and transmits the output rate estimate 408 to one or more services at the following stage. The scaling control unit 403 outputs the scaling request 406 based upon the information gathering response 405 from the cloud management server 401, and transmits it to the cloud management server 401 to the output rate estimating unit 402.

FIG. 4C shows an example corresponding to the end point service, no output controller is provided, and only the scaling control unit 403 is provided. The scaling control unit 403 corresponds to a scaling control unit A described later. In the case of the configuration shown in FIG. 4C, the scaling control unit 403 that receives an output rate estimate 407 from one or more services at the previous stage and an information gathering response 406 outputs a scaling request to the cloud management server 401.

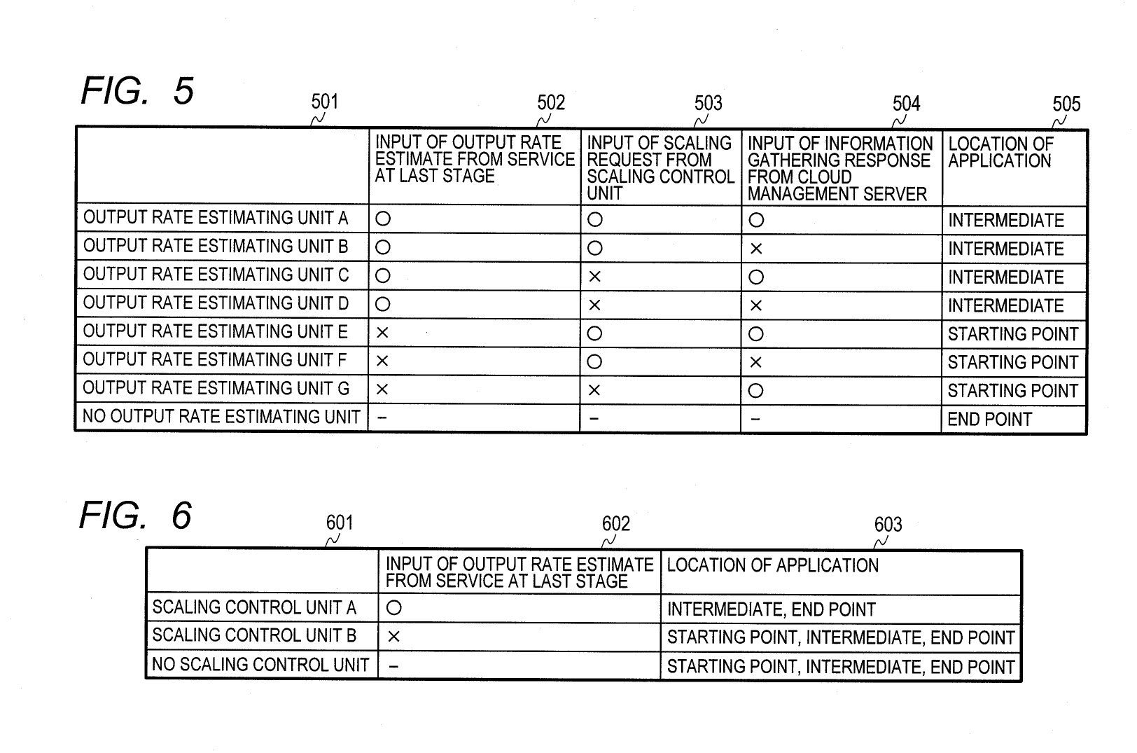

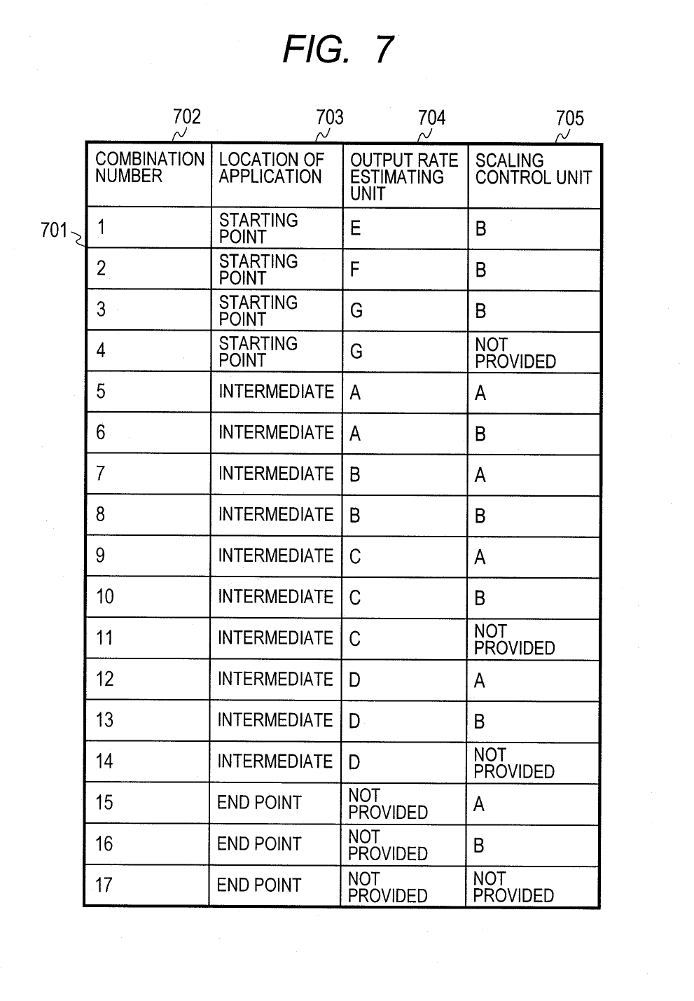

Next, FIG. 5 shows variations of the output rate estimating unit in the service linkage system in this embodiment, FIG. 6 shows variations of the scaling control unit in the service linkage system in this embodiment, and FIG. 7 shows combinations of the variations of the output rate estimating unit and the scaling control unit in the cloud in this embodiment.

In a variation table 501 shown in FIG. 5, input (O), not input (×) and not corresponding (−) are shown in each item of the input 502 of an output rate estimate from service at the previous stage, the input 503 of a scaling request from the scaling control unit and the input 504 of an information gathering response from the cloud management server. A reference numeral 505 denotes which of a starting point, an intermediate point and an end point in a work flow described later is a location of the application of the output rate estimating unit.

In a variation table 601 shown in FIG. 6, it is shown in a field shown by 602 whether an output rate estimate from the previous stage is input or not and a location of the application of the scaling control unit, that is, a starting point, an intermediate point or an end point in a work flow described later is shown in a field shown by 603.

In a combination table 701 shown in FIG. 7, each field 703, 704, 705 of a location of application, the output rate estimating unit and the scaling control unit are shown corresponding to a combination number 702. As for the output rate estimating unit and the scaling control unit, separate servers in the cloud may also be used or they may also be operated in virtual servers, and both may also be operated in one server or one virtual server. Further, one or both may also be operated in a server or a virtual server outside the cloud. However, a configuration when the combination of no output rate estimating unit and a scaling control unit B in a combination number 16 is included in all combination numbers in the work flow is equivalent to the configuration of a conventional type.

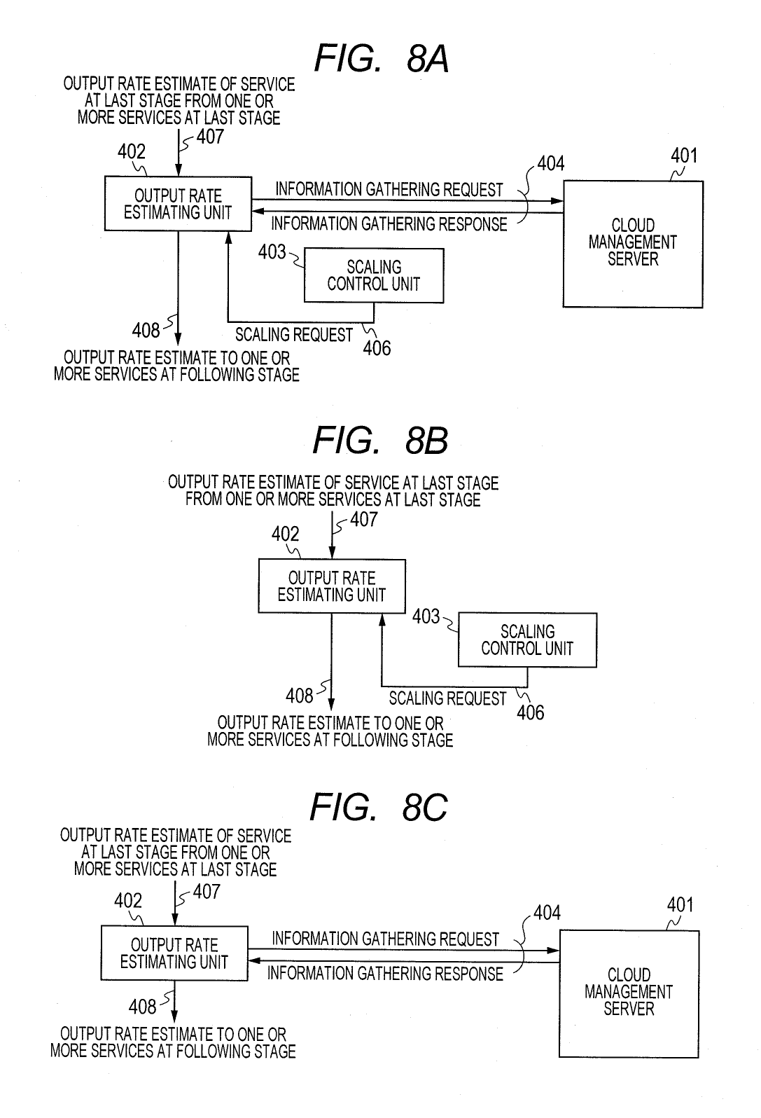

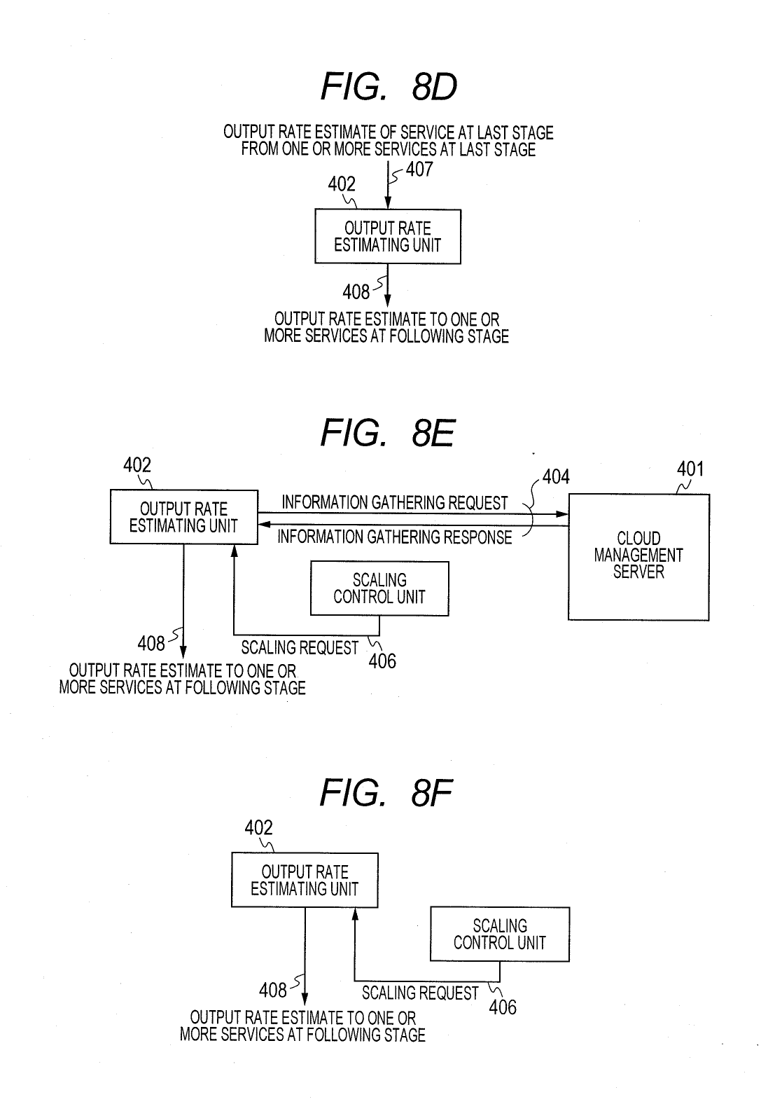

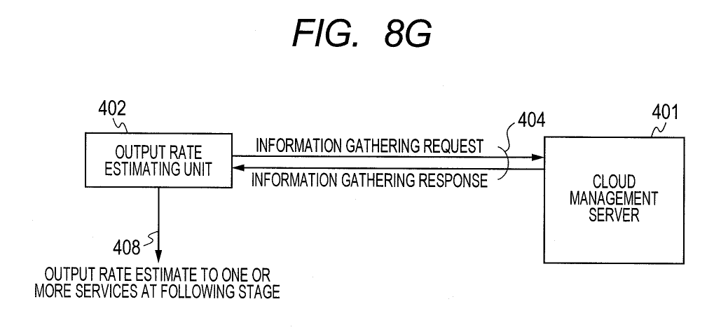

Referring to FIGS. 8A to 8G, the configuration of the connection of output rate estimating units A to G shown in the variation table in FIG. 5 will be described below. In FIGS. 8A to 8G, as for the input-output of the cloud management server 401 and the scaling control unit 403, only input-output related to the output rate estimating unit 402 is shown and the other input-output is omitted. Reference numerals in FIGS. 8A to 8G correspond to those in FIGS. 4A to 4C.

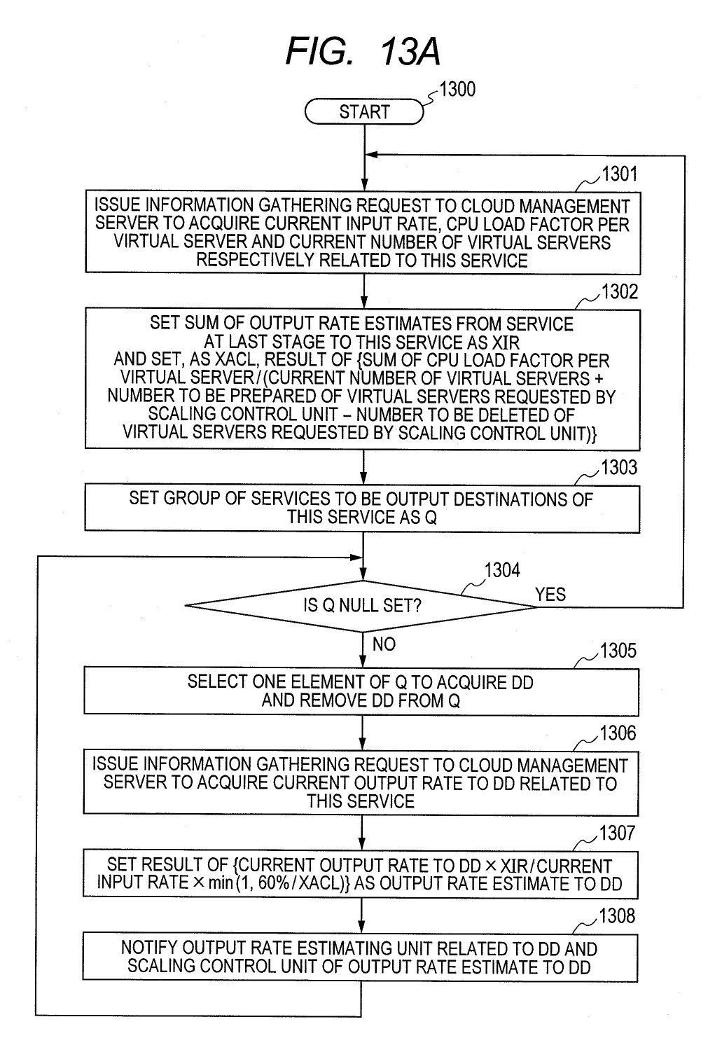

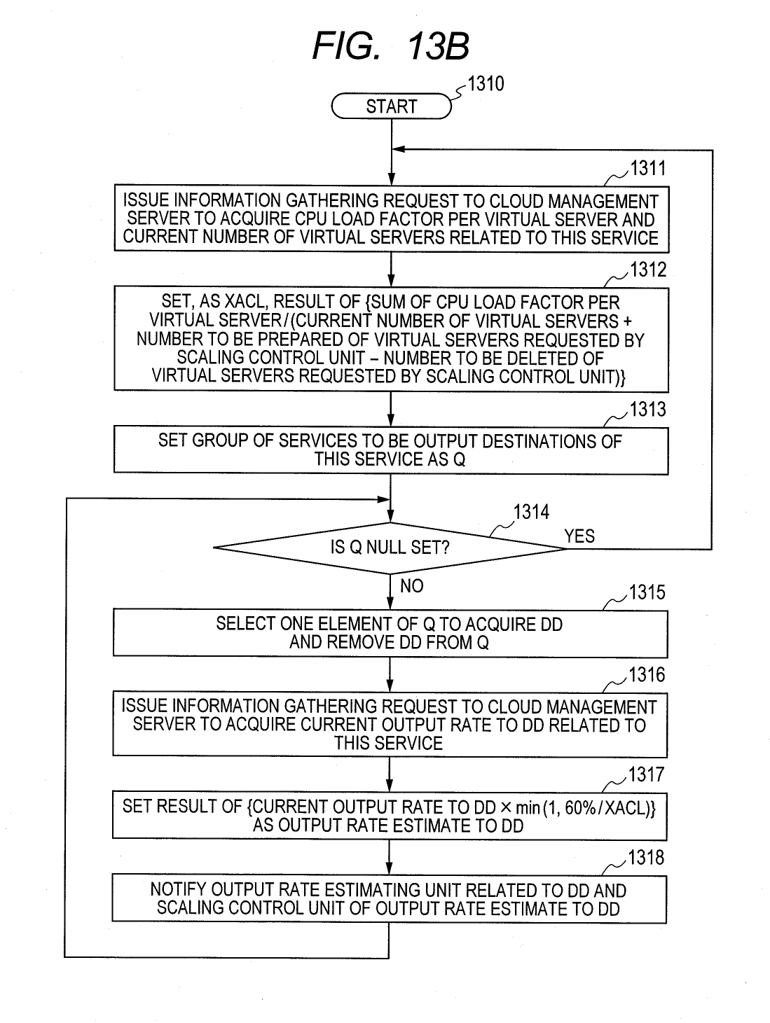

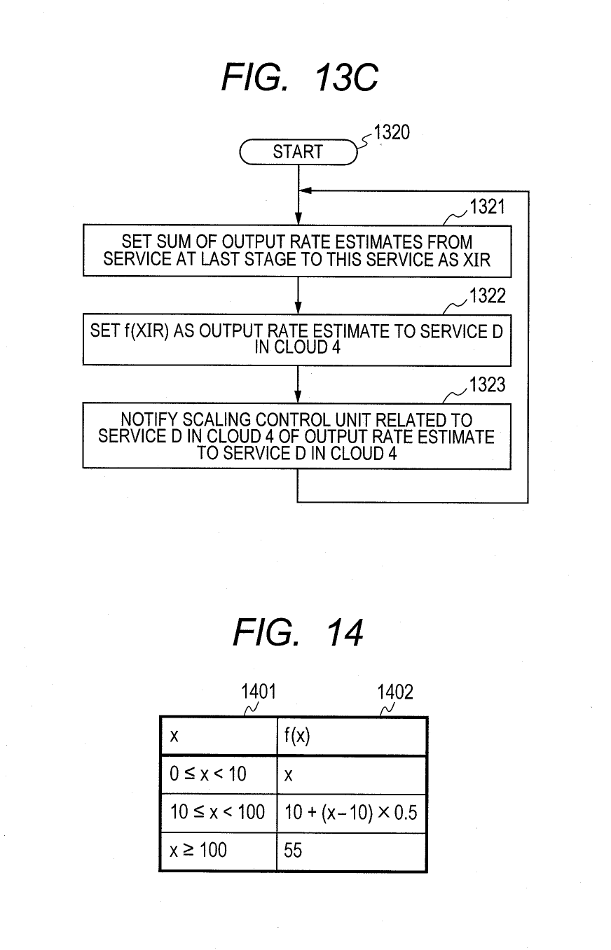

First, FIG. 8A shows an output rate estimating unit A shown in the table in FIG. 5. Since the output rate estimating unit 402 shown in FIG. 8A corresponds to the configuration and the operation shown in FIG. 4A, the description is omitted. Referring to FIG. 13A, contents of the processing of the output rate estimating unit A will be described later.

FIG. 8B shows one example of the configuration of an output rate estimating unit B shown in the table 501 in FIG. 5. Since an information gathering response from the cloud management server 401 is not input to the output rate estimating unit 402 as shown in FIG. 5, the output rate estimating unit receives one or more output rate estimates 407 from service at the previous stage and a scaling request 406 from the scaling control unit 401, estimates, and outputs an output rate estimate 408. A location of application is intermediate service as shown in the table in FIG. 5.

FIG. 8C shows one example of the configuration of an output rate estimating unit C shown in the table in FIG. 5. The output rate estimating unit 402 receives one or more output rate estimates 407 from service at the previous stage and an information gathering response 404 from the cloud management server 401, estimates, and outputs an output rate estimate 408. No scaling request 405 from the scaling control unit 401 is input to the output rate estimating unit 402 as shown in FIG. 5. A location of application is intermediate service.

FIG. 8D shows one example of the configuration of an output rate estimating unit D shown in the table in FIG. 5. As shown in FIG. 5, only one or more output rate estimates 407 from service at the previous stage are input to the output rate estimating unit D, the output rate estimating unit D makes an estimate based upon the output rate estimates 407, and outputs the output rate estimate 408. Contents of the processing of the output rate estimating unit D will be described later.

FIG. 8E shows one example of the configuration of an output rate estimating unit E shown in the table in FIG. 5. As shown in FIG. 5, one or more output rate estimates from service at the previous stage are not input to the output rate estimating unit E, a location of application is a starting point, the output rate estimating unit E makes an estimate based upon an information gathering response 404 from the cloud management server 401 and a scaling request 406 from the scaling control unit 401, and outputs the output rate estimate 408 to one or more services at the following stage. Contents of the processing of the output rate estimating unit E will be described later.

FIG. 8F shows one example of the configuration of an output rate estimating unit F. As shown in the table 501 in FIG. 5, the output rate estimating unit F estimates based upon only a scaling request 406 from the scaling control unit 401, and outputs an output rate estimate 408 to one or more services at the following stage. A location of application is starting point service.

FIG. 8G shows one example of the configuration of an output rate estimating unit G. As shown in the table 501 in FIG. 5, the output rate estimating unit G receives only an information gathering response 404 from the cloud management server 401, estimates, and outputs an output rate estimate 408 to one or more services at the following stage.

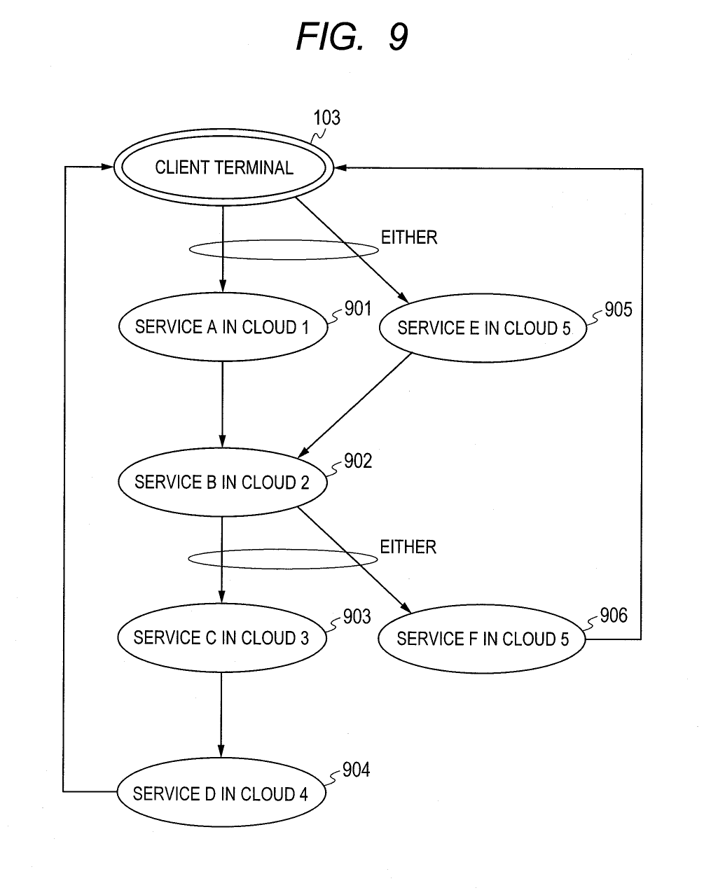

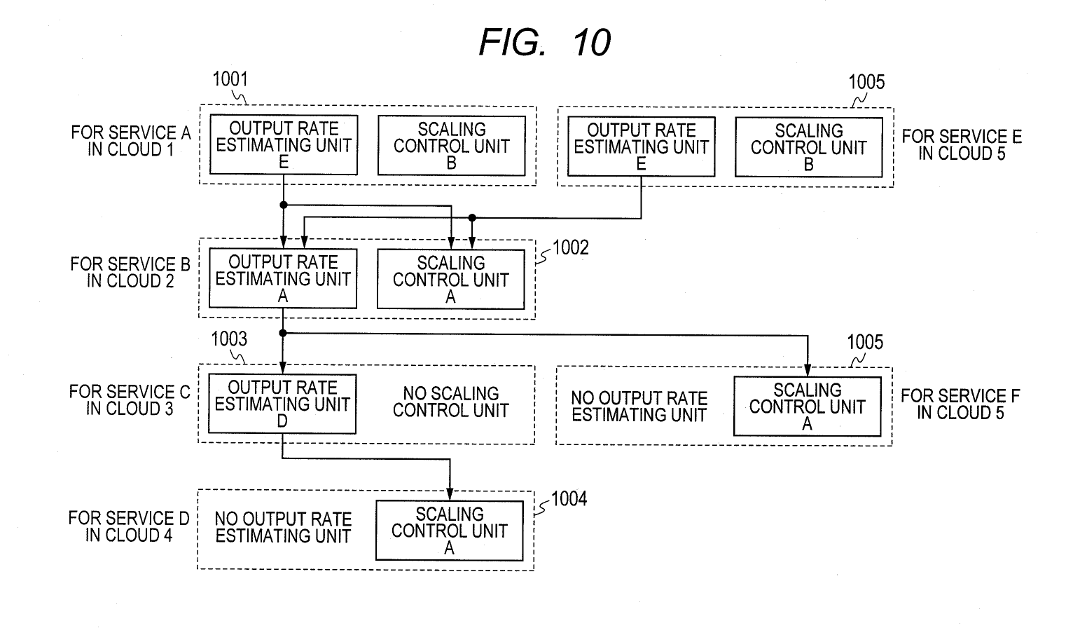

FIG. 9 shows the work flow of the service linkage system in this embodiment and FIG. 10 shows relation between the output rate estimating unit and the scaling control unit for each corresponding service. As shown in FIG. 9, the service linkage system in this embodiment executes corresponding processing according to an instruction to configure service from a client terminal 103. The client terminal 103 corresponds to the plural client terminals 103 shown in FIG. 1.

As shown in FIG. 9, first, an instruction to configure service A in the cloud 1 or an instruction to configure service E in the cloud 5 is given from the client terminal 103. Similarly, an instruction to configure service B in the cloud 2 is given from the client terminal 103. Output which is a result of processing in the service A in the cloud or the service E in the cloud 5 respectively at the previous stage is input to the service B. That is, the service B executes its processing using the result of the processing in the service A or the service E.

Further, an instruction to configure service C in the cloud 3 or an instruction to configure service F in the cloud 5 and an instruction to configure service D in the cloud 4 are given from the client terminal 103. As shown in FIG. 9, the service B in the cloud 2 branches to one of the service C in the cloud 3 and the service F in the cloud 5 at the following stage depending upon a result of its processing. Service D in the cloud 4 executes processing using output which is a result of processing in the service C in the cloud 3.

FIG. 10 shows relation between the output rate estimating unit 402 and the scaling control unit 403 per service which corresponds to one example of the work flow in this embodiment shown in FIG. 9 as described above. A reference numeral 1001 shown in FIG. 10 denotes the output rate estimating unit and the scaling control unit respectively corresponding to the service A 901 in the cloud 1 shown in FIG. 9 and more specifically, denotes the output rate estimating unit E and the scaling control unit B. Similarly, reference numerals 1002 to 1006 denote the output rate estimating unit and the scaling control unit respectively corresponding to each service 902 to 906 shown in FIG. 9.

The cloud 3 is software as a service (SaaS) that provides no interface for an information gathering request and a scaling request from a cloud user. Therefore, the output rate estimating unit D for the service C in the cloud 3 is realized using a virtual server outside the cloud 3, for example in the cloud 4. In the meantime, the cloud 1, the cloud 2, the cloud 4 and the cloud 5 are infrastructure as a service (IaaS) that provides an interface for an information gathering request and a scaling request from a cloud user, and these output rate estimating unit and scaling control unit can be realized using a virtual server in each cloud.

As clear from FIG. 10, 1001 for the service A in the cloud 1 and 1005 for the service E in the cloud 5 function as the starting point, 1002 for the service B in the cloud 2 and 1003 for the service C in the cloud 3 function as the intermediate point, and 1004 for the service D in the cloud 4 and 1006 for the service F in the cloud 5 function as the end point.

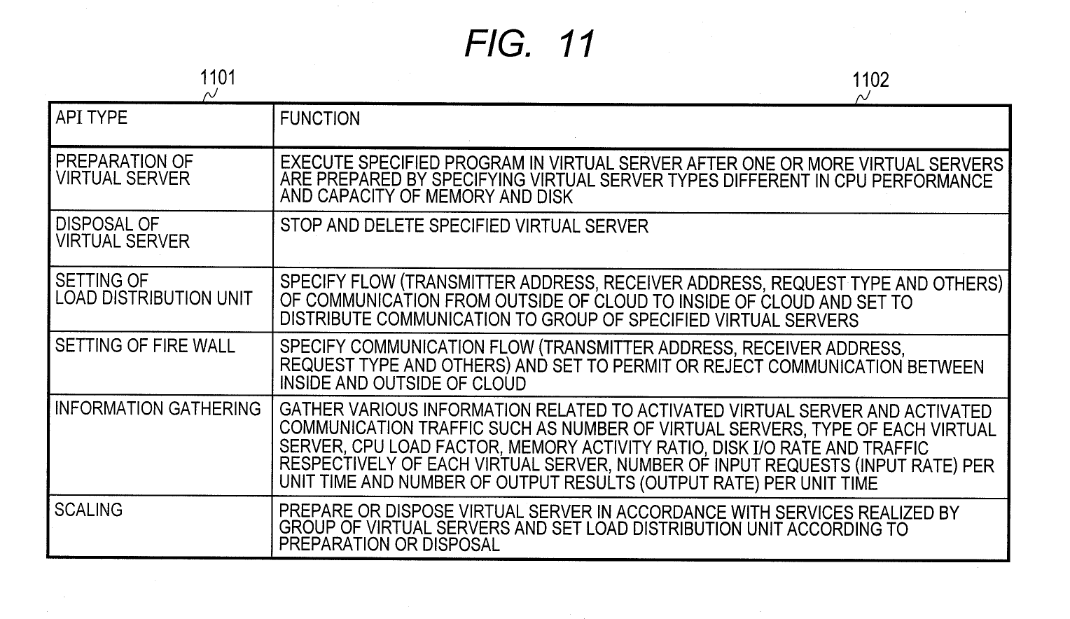

FIG. 11 shows a list of application program interfaces (API) which are provided to each cloud user by the cloud management server 109 and which correspond to the plural clouds in this embodiment. The APIs are provided when the clouds 1, 2, 4, 5 out of the five clouds 1 to 5 corresponding to the work flow shown in FIG. 9 and configuring the service linkage system function as IaaS as described above. The cloud 3 functions only as SaaS as described above.

As shown in FIG. 11, as an API type 1101, the preparation of a virtual server, the disposal of a virtual server, the setting of the load distribution unit, the setting of the firewall, information gathering and scaling are shown and are provided with each function 1102. The preparation of the virtual server is provided with a function of executing a program specified in the virtual server after one or more virtual servers are prepared by specifying virtual server types different in CPU performance and the capacity of the memory and the disk. The disposal of the virtual server provides a function of stopping and deleting the specified virtual server.

Besides, the setting of the load distribution unit is provided with a function of setting to specify a flow of communication (a transmitter address, a receiver address, a request type and others) from the outside of the cloud to the inside of the cloud and to distribute the communication to a specified group of virtual servers. The setting of the firewall is provided with a function of setting to specify a communication flow (a transmitter address, a receiver address, a request type and others) and to permit or reject communication between the inside and the outside of the cloud.

The information gathering provides a function for gathering various information related to an activated virtual server and traffic, for example the number of virtual servers, a type of each virtual server, a CPU load factor, the activity ratio of a memory, an I/O rate of a disk, traffic, the number of input requests (an input rate) per unit time and the number of results of output (an output rate) per unit time respectively of each virtual server. Finally, the scaling provides a function of preparing or disposing a virtual server and of setting the load distribution unit according to it out of services realized by a group of virtual servers.

In the meantime, the cloud 3 is SaaS as described above, is not provided with such API, and provides only an interface for executing the service C shown in FIG. 9 to a cloud user as the whole. Various setting such as scaling inside the cloud is suitably performed by a business that operates the cloud 3 and is not presented to a cloud user.

Next, referring to FIGS. 9, 10, 11 and others, a procedure for configuring linkage service by deploying service to each cloud in the work flow shown in FIG. 9 in this embodiment will be described.

The client terminal 103 instructs the cloud management server 109 of the cloud 1 to configure the service A. A concrete procedure is as follows.

(1) It is instructed to prepare some (for example, three) virtual servers that execute a program for realizing the service A using virtual server preparing API shown in FIG. 11. In this case, a type of the virtual servers is unified.

(2) It is instructed to distribute a load of service execution requests from the outside of the cloud to a group of the prepared virtual servers using load distribution unit setting API.

(3) It is instructed to prepare a virtual server that executes a program for realizing the output rate estimating unit E and a virtual server that executes a program for realizing the scaling control unit B respectively corresponding to the starting point service shown in FIG. 4B using the virtual server preparing API.

(4) It is instructed to enable communicating an output rate estimate as a result of the execution request and an output of the service A with the outside of the cloud using firewall setting API.

Similarly, the client terminal 103 instructs the cloud management server 109 of the cloud 5 to configure the service E. A procedure for configuring the service E based upon this instruction is similar to the above-mentioned procedure for configuring the service A related to the cloud 1 and the description is omitted.

Similarly, the client terminal 103 instructs the cloud management server 109 of the cloud 2 to configure the service B. Concretely, the following procedure will be executed.

(1) It is instructed to prepare some (for example, three) virtual servers that execute a program for realizing the service B using virtual server preparing API. In this case, a virtual server type is unified.

(2) It is instructed to distribute a load of service B execution requests from the outside of the cloud to a group of the prepared virtual servers using load distribution unit setting API.

(3) It is instructed to prepare a virtual server that executes a program for realizing the output rate estimating unit A shown in FIG. 4A and a virtual server that executes a program for realizing the scaling control unit A using the virtual server preparing API.

(4) It is instructed to enable communicating an output rate estimate as a result of the execution request and an output of the service B and an output rate estimate from another cloud with the outside of the cloud using firewall setting API.

Similarly, the client terminal 103 instructs the cloud management server 109 of the cloud 4 to configure the service D. A concrete procedure is as follows.

(1) It is instructed to prepare some (for example, three) virtual servers that execute a program for realizing the service D using virtual server preparing API. A virtual server type is unified.

(2) It is instructed to distribute a load of service D execution requests from the outside of the cloud to a group of the prepared virtual servers using load distribution unit setting API.

(3) It is instructed to prepare a virtual server that executes a program for realizing the scaling control unit A and a virtual server that executes a program for realizing the output rate estimating unit D for the service C in the cloud 3 using the virtual server preparing API. The latter is prepared to realize the output rate estimating unit D for the service C in the cloud 3 which is SaaS as described above.

(4) It is instructed to enable communicating an output rate estimate from another cloud as a result of the execution request and an output of the service D with the outside of the cloud using firewall setting API.

Similarly, the client terminal 103 instructs the cloud management server 109 of the cloud 5 to configure the service F. A concrete procedure is similarly as follows.

(1) It is instructed to prepare some (for example, three) virtual servers that execute a program for realizing the service F using virtual server preparing API. A virtual server type is unified.

(2) It is instructed to distribute a load of service F execution requests from the outside of the cloud to a group of the prepared virtual servers using load distribution unit setting API.

(3) It is instructed to prepare a virtual server that executes a program for realizing the scaling control unit A using the virtual server preparing API.

(4) It is instructed to enable communicating an output rate estimate from another cloud as a result of the execution request and an output of the service F with the outside of the cloud using firewall setting API.

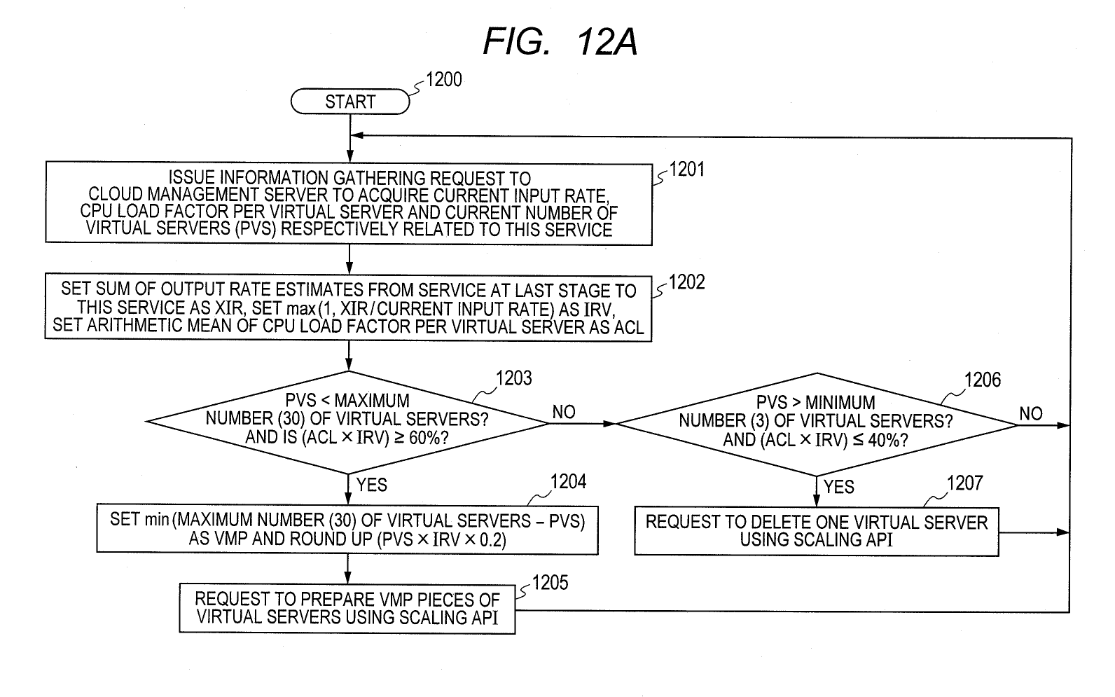

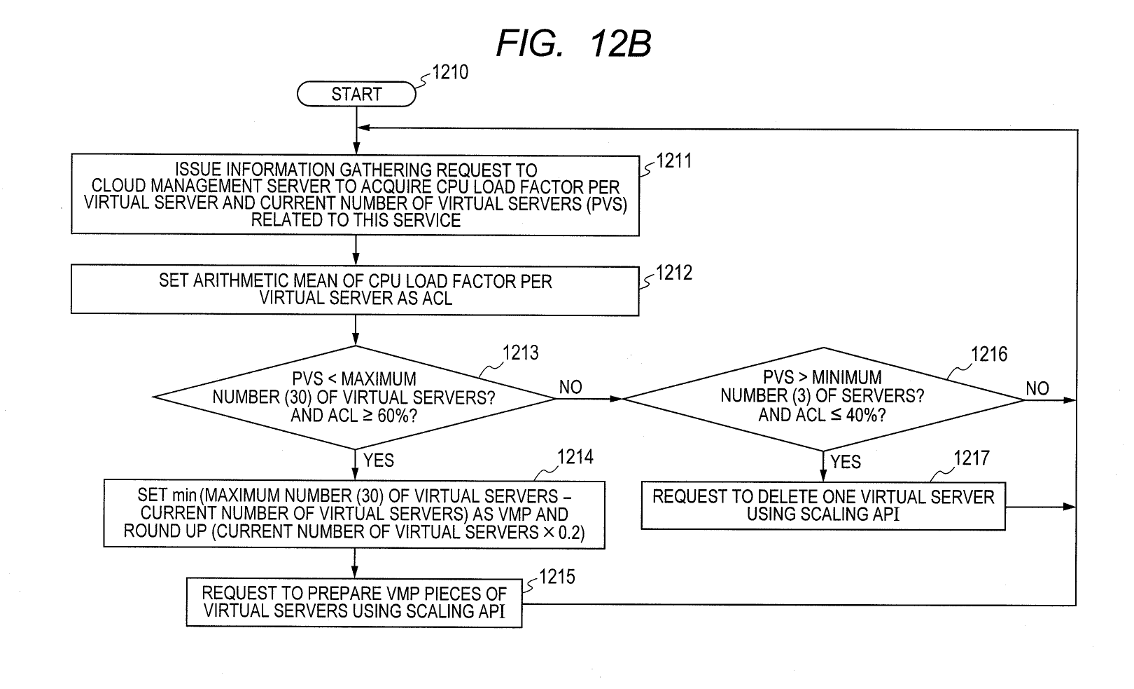

Next, examples of the concrete functional configuration of the variations realized by each cloud of the output rate estimating unit 402 and the scaling control unit 403 in the service linkage system in this embodiment will be described, referring to FIGS. 12A, 12B, 13A, 13B and 13C.

FIG. 12A shows one example of a process flow of the scaling control unit A shown in the table in FIG. 6. As described above, the output rate estimating unit and the scaling control unit can be realized by programs executed in the server and the virtual server. It is also similar in the following example of another functional configuration. In FIG. 12A, when the processing of the scaling control unit A is started (a step 1200, hereafter, a step in parentheses is omitted), an information gathering request 405 is issued to the cloud management server 401, and “the current input rate”, “a CPU load factor every virtual server” and “the current number of virtual servers (PVS)” respectively related to this service are acquired as an information gathering response 405 (1201).

Next, the scaling control unit A sets the sum of output rate estimates from at least one service at the previous stage to this service as an expected input rate (XIR), sets a maximum value (1) acquired by dividing XIR by the current input rate as an input rate variation rate (IRV), and sets the arithmetic mean of a CPU load factor every virtual server as an average CPU load (ACL) as shown in the step 1202 in FIG. 12A. In a step 1203, it is determined whether the current number of virtual servers (PVS) is smaller than the maximum number of virtual servers (30) or not and whether “the arithmetic mean (ACL)×IRV”≧60% or not.

When a result of the determination is Yes, the processing proceeds to a step 1204 and a smaller value of two values shown in the step 1204 is set as virtual machine, plus (VMP). In a step 1205, the preparation of VMP units of virtual server is requested using scaling API and control is returned to the step 1201.

In the meantime, when the result of the determination in the step 1203 is No, the processing proceeds to a step 1206 and it is determined whether the current number of virtual servers (PVS) is larger than the minimum number of virtual servers (3) or not and whether “the arithmetic mean (ACL)×IRV”≦40% or not. When a result of the determination is Yes, the processing proceeds to a step 1207 and the deletion of one virtual server is requested using scaling API. Afterward, control is returned to the step 1201. When the result of the determination is No, control is also returned to the step 1201.

Similarly, FIG. 12B shows one example of a process flow of the scaling control unit B which is shown in the table 601 in FIG. 6 and to which no output rate estimate is input from service at the previous stage. As in FIG. 12A, when processing is started in a step 1210, an information gathering request 405 is issued to the cloud management server 401, and “a CPU load factor per virtual server” and “the current number of virtual servers (PVS)” respectively related to this service are acquired (1211). The arithmetic mean of “the CPU load factor per virtual server” is set as ACL (1212). In a step 1213, it is determined whether the current number of virtual servers (PVS) is smaller than the maximum number of virtual servers (30) or not and whether the arithmetic mean (ACL)≧60% or not. When a result of the determination is Yes, the processing proceeds to a step 1214 and a smaller value of two values shown in the step 1214 is set as VMP. In a step 1215, the preparation of VMP units of virtual server is requested using scaling API and control is returned to the step 1211.

In the meantime, when the result of the determination in the step 1213 is No, the processing proceeds to a step 1216 and it is determined whether the current number of virtual servers (PVS) is larger than the minimum number of virtual servers (3) or not and whether the arithmetic mean (ACL)≦40% or not. When a result of the determination is Yes, the processing proceeds to a step 1217 and the deletion of one virtual server is requested using scaling API. Afterward, control is returned to the step 1211. When the result of the determination is No as well, control is returned to the step 1211.

When the output rate estimate is input from the service at the previous stage and when no output rate estimate is input, the above-mentioned scaling control can be executed by the scaling control unit in this embodiment.

FIG. 13A shows one example of processing by the output rate estimating unit A in this embodiment. When the processing is started (1300), the output rate estimating unit A issues an information gathering request 404 to the cloud management server 401 as shown in FIG. 8A, and the current input rate, a CPU load factor per virtual server and the current number of virtual servers respectively related to this service are acquired as an information gathering response 404 (1301).

The output rate estimating unit A sets the sum of output rate estimates from at least one service at the previous stage to this service as XIR and sets a result of {“the sum of the CPU load factor per virtual server”/“the current number of virtual servers”+“the number of virtual servers to be prepared requested by the scaling control unit”−“the number of virtual servers to be deleted requested by the scaling control unit”} as an expected average CPU load (XACL) (1302). Besides, the output rate estimating unit A sets a group of services to which this service is output as Q (1303). In a step 1304, it is checked whether the group of services Q is a null set or not and when the group is the null set, control is returned to the first step.

When the group is not a null set, one element of Q is selected, is set as DD, and the DD is removed from Q (1305). An information gathering request 404 is issued to the cloud management server 401, “the current output rate to DD” related to this service is acquired (1306), a result of (“the current output rate to DD”×“XIR”/“the current input rate”×“a minimum value (1, acquired by dividing 60% by XACL)”} is set as an output rate estimate to DD (1307), and the output rate estimating unit and the scaling control unit respectively for DD are notified of the output rate estimate to DD (1308).

FIG. 13B shows one example of processing by the output rate estimating unit E the location of application of which is the starting point. When the processing is started as in FIG. 13A (1310), the output rate estimating unit E issues an information gathering request 404 to the cloud management server 401 as shown in FIG. 8E and acquires a CPU load factor per virtual server and the current number of virtual servers respectively related to this service (1311). The output rate estimating unit E sets a result of {“the sum of the CPU load factor per virtual server”/“the current number of virtual servers”+“the number of virtual servers to be prepared requested by the scaling control unit”−“the number of virtual servers to be deleted requested by the scaling control unit”} as XACL (1312). Besides, the output rate estimating unit E sets a group of services to which this service is output as Q (1313). In a step 1314, the output rate estimating unit E checks whether the group Q of services is a null set or not and when the group Q is the null set, control is returned to the first step.

When the group is not a null set, one element of Q is selected, is set as DD, and the DD is removed from Q (1315). An information gathering request 404 is issued to the cloud management server 401, “the current output rate to DD” related to this service is acquired (1316), a result of {“the current output rate to DD”×“a minimum value (1, acquired by dividing 60% by XACL)”} is set as “an output rate estimate to DD” (1317), and the output rate estimating unit and the scaling control unit respectively for DD are notified of the output rate estimate to DD (1318).

Similarly, FIG. 13C shows one example of processing by the output rate estimating unit D for the service C in the cloud 3. When the processing is started (1320), the output rate estimating unit D sets, as XIR, the sum of output rate estimates from at least one service at the previous stage to this service (1321), sets f (XIR) defined in FIG. 14 as an output rate estimate to the service D in the cloud 4 (a step 1322), and notifies the scaling control unit for the service D in the cloud 4 of the output rate estimate to the service D in the cloud 4 (1323).

As shown in 1401 and 1402 in FIG. 14, f (x) varies according to a value of “x”; however, f (x) is equivalent to a function acquired by measuring beforehand the relation of output rates to input rates.

One embodiment of the present invention has been described in detail. It goes without saying, however, that the present invention is not limited to the configuration of the embodiment. It also goes without saying that the plural clouds described as the example of the plural information processing systems that configure the service linkage system can realize the present invention whether the plural clouds are provided by the same business or they are provided by different businesses. The provided and linked plural services can execute the present invention not only when the plural services are realized in different clouds but when some or all services are realized in the same cloud.

The service linkage system and the information processing system according to the present invention are useful for a system that provides various services via a network, particularly a service linkage system that provides service with plural information processing systems linked and the information processing system.

What is claimed is:

1. A service linkage system that links a plurality of services executed in one or more information processing systems,
wherein resources allocated to a second service of the plurality of services are determined using a result acquired by estimating the processing performance of a first service of the plurality of services.

2. The service linkage system according to claim 1,
wherein the processing performance of the second service is estimated using the result acquired by estimating the processing performance of the first service.

3. The service linkage system according to claim 1,
wherein the resources allocated to the second service are determined in the information processing system that executes the second service.

4. The service linkage system according to claim 1,
wherein the processing performance of the first service is estimated in the information processing system that executes the first service.

5. The service linkage system according to claim 1,
wherein the second service is processed using a result of the processing of the first service.

6. The service linkage system according to claim 1, comprising:
a first performance estimating unit that estimates the processing performance of the first service; and
a second performance estimating unit that estimates the processing performance of the second service,
wherein the second performance estimating unit estimates the processing performance of the second service using a result of an estimate of the processing performance of the first service by the first performance estimating unit.

7. The service linkage system according to claim 1,
wherein the first service and the second service are executed in the different information processing systems.

8. The service linkage system according to claim 1, comprising:
a performance estimating unit to which a result acquired by estimating the processing performance of the first service is input and which estimates the processing performance of the second service based upon the result of the estimate of the processing performance of the first service; and
a resource allocation control unit that determines resources allocated to the second service.

9. The service linkage system according to claim 8,
wherein the resource allocation control unit determines resources allocated to the second service using the result of the estimate of the processing performance of the first service.

10. The service linkage system according to claim 8,
wherein the performance estimating unit estimates the processing performance of the second service using information of the resources allocated to the second service determined by the resource allocation control unit.

11. An information processing system that provides a plurality of services in linkage at least with another information processing system connected via a network, comprising:
a management unit; and
a plurality of servers connected to the management unit and managed by the management unit,
wherein the server is provided with storage that stores one or more programs and a processing unit that executes the programs; and
the management unit determines and allocates resources allocated to a second service of the plurality of services using a result acquired by estimating the processing performance of a first service of the plurality of services.

12. The information processing system according to claim 11,
wherein the management unit estimates the processing performance of the second service using the result acquired by estimating the processing performance of the first service.

13. The information processing system according to claim 12,
wherein the processing of the second service, the processing performance of which is estimated, is executed.

14. The information processing system according to claim 12,
wherein the processing of the second service is executed using a result of the processing of the first service.

15. The information processing system according to claim 12,
wherein the management unit is provided with a performance estimating unit to which a result acquired by estimating the processing performance of the first service is input and which estimates the processing performance of the second service based upon the result of the estimate of the processing performance of the first service and a resource allocation control unit that determines resources allocated to the second service.

16. An information processing system that provides a plurality of services in linkage at least with another information processing system connected via a network, comprising:
a management unit; and
a plurality of servers connected to the management unit and managed by the management unit,
wherein the server is provided with storage that stores one or more programs and a processing unit that executes the programs; and
the management unit estimates the processing performance of a second service of the plurality of services using a result acquired by estimating the processing performance of a first service of the plurality of services.

17. The information processing system according to claim 16,
wherein the management unit determines and allocates resources allocated to the second service using the result acquired by estimating the processing performance of the first service.

18. The information processing system according to claim 16,
wherein the processing of the second service, the processing performance of which is estimated, is executed.

19. The information processing system according to claim 16,
wherein the processing of the second service is executed using a result of the processing of the first service.

20. The information processing system according to claim 16,
wherein the management unit is provided with a performance estimating unit to which the result acquired by estimating the processing performance of the first service is input and which estimates the processing performance of the second service based upon the result of the estimate and a resource allocation control unit that determines resources allocated to the second service.
